(19) United States
(12) Patent Application Publication
(10) Pub. No.: US 2019/0358755 A1
(43) Pub. Date: Nov. 28, 2019

(54) METHOD AND DEVICE FOR THE POWDER BED-BASED ADDITIVE BUILDING UP OF A PLURALITY OF IDENTICAL COMPONENTS

(71) Applicant: SIEMENS AKTEINGESELLSCHAFT, Munich (DE)

(72) Inventor: Michael OTT, Mulheim an der Ruhr (DE)

(73) Assignee: Siemens Aktiengesellschaft, Munich (DE)

(21) Appl. No.: 16/476,279

(22) PCT Filed: Jan. 25, 2018
(86) PCT No.: PCT/EP2018/051853

§ 371 Date: Jul. 6, 2019

(30) Foreign Application Priority Data
Feb. 8, 2017 (DE) 10 2017 201 994.8

(51) Int. Cl. B23P 6/00; B33Y 10/00; B33Y 30/00; B23K 26/02; B23K 26/08; B23K 26/342

(52) U.S. Cl. CPC B23P 6/007; B33Y 10/00; B33Y 30/00; B23K 2101/001; B23K 26/083; B23K 26/0884; B23K 26/342; B23K 26/02

(57) ABSTRACT

A method and to device for the powder bed-based additive building up of a plurality of identical components, including fixing of each of the components on a base plate by a retaining apparatus, adjusting of a vertical position of at least some of the fixed components relative to the base plate, such that a structural peak of each component is spaced apart from the base plate within a predetermined tolerance range, providing a powder bed of a building material on the base plate up to a height of the tolerance range and layered, additive building up of material on each of the structural peaks of the components.

### CROSS REFERENCE TO RELATED APPLICATIONS

This application is the US National Stage of International Application No. PCT/EP2018/051853 filed Jan. 25, 2018, and claims the benefit thereof. The International Application claims the benefit of German Application No. DE 10 2017 201 994.8 filed Feb. 8, 2017. All of the applications are incorporated by reference herein in their entirety.

### FIELD OF INVENTION

The present invention relates to a method for the powder bed-based additive manufacturing of a plurality of components, in particular the repair of components, and to a corresponding device.

The components, in particular identical components, are intended in particular for use in a turbomachine, advantageously in the hot gas path of a gas turbine. The components are in particular moving turbine blades or their airfoils. Accordingly, the components may comprise in each case a nickel-based or cobalt-based superalloy, or consist thereof. The alloy may be precipitation-hardened or precipitation-hardenable. The components may alternatively or additionally be worn and/or partly produced or built-up components.

### BACKGROUND OF INVENTION

Generative or additive manufacturing methods comprise for example, as powder bed methods, selective laser melting (SLM) or laser sintering (SLS), or electron beam melting (EBM). Similarly, the additive methods include laser metal deposition (LMD).

A method for selective laser melting is known for example from EP 2 601 006 B1.

Additive manufacturing methods have proven to be particularly advantageous for components that are complex or of a complicated or filigree design, for example labyrinthine structures, cooling structures and/or lightweight structures. In particular, additive manufacturing is advantageous as a result of a particularly short chain of process steps, since a step in the production or manufacture of a component can be performed directly on the basis of a corresponding CAD file.

Furthermore, additive manufacturing is particularly advantageous for the development or production of prototypes that cannot be produced by means of conventional subtractive or machining methods or casting technology, or cannot be produced efficiently by these means, for example for reasons of cost.

Moving blades of gas turbines often require a repair of the blade tip after the intended service interval. This is damaged during the use of the gas turbine by thermal, mechanical and/or corrosive effects. In order to carry out the repair, the damaged region is conventionally removed manually and subsequently built up by a welding method, for example laser metal deposition. The removal may be performed in a manual or (partly) automated manner.

It is known in the area of the production of turbine blades that the parts which, because of their requirements for the material composition and the complexity of the geometry, are produced by vacuum precision investment casting are subject to fluctuation in their dimensions (range of fluctuation). In particular, the length of the airfoil varies for production-related reasons, i.e. a reference point along the longitudinal axis of the airfoil or a nominal length is only defined to an accuracy within the range of several tenths of a millimeter.

In the same way as the described production-related fluctuation or “unsharpness” of the airfoil length, the removal of the airfoil tip, or a worn region, in preparation for building up the same again leads to variation or unsharpness with respect to the length of the remaining airfoil.

Furthermore, it is often desired to remove from the element only as much as is absolutely necessary, since a “refurbishing material” applied by welding (“refurbishment”) does not have the required or the same material quality or structure as the element originally produced, for example with regard to its hot crack susceptibility.

Consequently, the dimensions of the element or component to be repaired are subject to a certain unavoidable fluctuation or unsharpness with regard to its longitudinal extent. By contrast with powder bed-based additive manufacturing, said fluctuation is unproblematic in conventional repair methods, for example laser metal deposition or TIG welding.

If, however, it is wished to use additive and/or powder bed-based selective methods, such as for example selective laser melting, for building up the components again, this described fluctuation would lead to unacceptable results, or would decisively complicate the repair of a plurality of components in parallel by a powder bed-based method. The reason is that, in the case of powder bed-based methods, the position of a structural peak should be determined in relation to a substrate or a baseplate to within an amount that corresponds to the layer thickness used in the process. Usual layer thicknesses in the area of selective laser melting lie approximately between 20 and 80 μm. Consequently, such a tolerance range over which the tips of the components or elements vary from one another in the building-up direction—provided that they are all fixed directly on the baseplate—should lie in the range of the layer thicknesses, in order that no problems occur during the individual coating operations, in particular collisions.

### SUMMARY OF INVENTION

It is therefore an object of the present invention to provide means by which the additive manufacturing of a plurality of components on a powder bed is simplified, or the use of powder bed-based manufacturing technology can be extended, and thus the advantages of additive manufacturing technology can also be used more widely.

This object is achieved by the subject matter of the independent patent claims. Advantageous refinements are the subject of the dependent patent claims.

One aspect of the present invention relates to a method for the powder bed-based additive building up of a plurality of components comprising the fixing of each of the components on a baseplate, for example in an installation for the corresponding additive manufacturing, by means of a retaining or fixing device.

The method also comprises the setting of a vertical position or height position of at least some of the fixed components (by way of the retaining devices) in relation to the baseplate, so that a structural peak of each component is at a distance from the baseplate within a predetermined tolerance range. The described setting is advantageously an individual setting of each individual retaining device and may comprise a height measurement or distance measurement of the corresponding structural peaks from the surface of the baseplate.

In the present case, the described height, height position or vertical position should be understood as advantageously meaning a distance along a building-up direction of the components.

The method also comprises the providing of a powder bed of a building-up material, in particular in the form of powder, on the baseplate up to a height of the tolerance range. In other words, a building-up space is advantageously filled with powder up to a height corresponding to the depth of the powder bed, which corresponds to the distance of the tolerance range from the baseplate.

In the method described, the providing of the powder bed may be provided before or after the step of setting the vertical position.

The method also comprises additively building up material, advantageously by means of selective laser melting, layer by layer, in each case on the structural peak of the components. Said material advantageously corresponds to the building-up material fused by an energy beam. The components are advantageously additively built up in parallel or at the same time.

The structural peaks advantageously have in each case a building-up area which—as a result of the corresponding fixing on the baseplate—is expediently facing away from the surface of the baseplate.

In one refinement, the setting of the vertical position and/or a check of the vertical position is carried out after each built-up layer of material.

A further aspect of the present invention relates to a device for powder bed-based additive manufacturing, comprising a baseplate and a plurality of retaining devices that are height-adjustable, and advantageously movable, independently of one another in relation to the baseplate, wherein the retaining devices are respectively designed to fix a component (as described above) in relation to the baseplate.

As indicated above, the removal and subsequent building up again of the damaged regions of a blade can be advantageously simplified and carried out by using advantageous additive manufacturing technology. In particular, a refurbishment of turbine parts can be carried out at lower cost. Similarly, component repairs can be individualized, for example in a way corresponding to the state of wear. Furthermore, with the method described, a plurality of components, in particular identical components, can be repaired or refurbished in parallel.

In one refinement, the method is a refurbishment or repair method.

In one refinement, the components are repair components.

In one refinement, before the fixing, material is in each case removed in a worn region of the components, and the structural peak is thus defined.

In one refinement, the components are cast components, in particular produced by precision investment casting, such as vacuum precision investment casting.

In one refinement, the components are forged components.

In one refinement, the components are identical.

In one refinement, the components are turbine blades, the structural peak representing an airfoil tip.

In one refinement, a nominal layer thickness for the additive building up of layers corresponds to a dimension of the tolerance range at a distance from the baseplate. The tolerance range is typically 10 to 80 μm, advantageously 20 to 30 μm. By this refinement it can be ensured in particular that there are no problems with a coater unit of the additive manufacturing installation during the process of manufacturing or repairing the components, in particular collisions. This is so because, if according to the method described the structural peaks of the components are arranged within the tolerance range, they are within the layer or layer thickness of a new application of material for the application of material or the repair, and a collision with the coater unit is consequently ruled out.

In one refinement, a distance of each structural peak of the components in relation to the baseplate and/or in relation to the surface of the powder bed is measured during the additive building up of layers, for example after each or some of the fused layers. This refinement is expedient in particular to allow the vertical position of the fixed components to be set, as described, in the first place.

In one refinement, the predetermined tolerance range, for example measured along a building-up direction, is 10 to 80 μm, advantageously 20 to 30 μm.

In one refinement, each retaining device is designed to be height-adjustable, for example by way of a guide in the baseplate.

In one refinement, each retaining device has a carrier and/or a clamping device. By way of the carrier or the clamping device(s), in particular clamping jaws or comprising such clamping jaws, the components are expediently fixed.

In one refinement, the carrier, the clamping device and/or the retaining device is designed to be movable and/or height-adjustable in relation to the baseplate by way of hydraulic, pneumatic, electromechanical or piezoelectric means.

In one refinement, the device has at least four retaining devices. Accordingly, for example four components can be additively built up or refurbished layer by layer in parallel.

In one refinement, the device has more than four retaining devices, for example six, eight or ten retaining devices.

Refinements, features and/or advantages which in the present case relate to the method may also relate to the device, or vice versa.

### BRIEF DESCRIPTION OF THE DRAWINGS

Further details of the invention are described below on the basis of the figures.

FIG. 1 shows a schematic perspective view of a device of the present invention.

FIG. 2 shows a schematic sectional or side view of at least part of the device.

FIG. 3 shows a schematic sectional view of the device during operation and indicates a method according to the invention.

FIG. 4 indicates method steps of the method on the basis of a schematic view.

FIG. 5 shows a schematic flow diagram of method steps of the method according to the invention.

### DETAILED DESCRIPTION OF INVENTION

In the exemplary embodiments and figures, elements that are the same or act in the same way may be provided in each case with the same designations. The depicted elements and their sizes in relation to one another are in principle not to be regarded as true to scale; rather, individual elements may be illustrated with exaggerated thickness or size dimensions for improved clarity and/or for improved understanding.

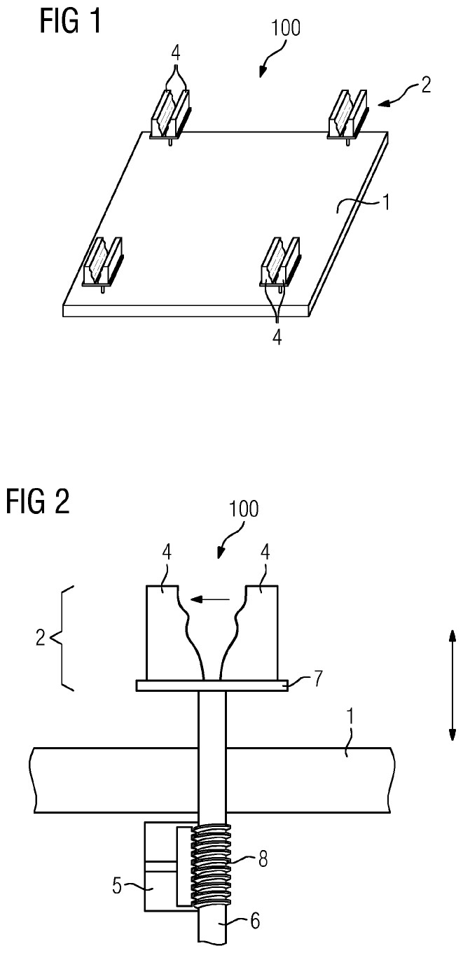

FIG. 1 shows a perspective view of a device 100. The device 100 is advantageously intended for use in an installation for powder bed-based additive manufacturing, advantageously by selective laser melting (SLM). The device 100 has a baseplate 1. The baseplate is expediently a baseplate for the additive manufacturing of metal components, in particular turbine elements.

The baseplate 1 may be a building platform similar to a building platform of a conventional additive manufacturing installation, for example a steel-based and/or low-distortion baseplate.

The baseplate 1 has a square or rectangular main surface. The device 100 also has a plurality of retaining devices 2. By way of example, four retaining devices 2 are arranged or fastened on said surface.

The retaining devices 2 are intended to fix components that are for example to be repaired or refurbished, in particular worn components, in relation to the baseplate 1 by way of the retaining devices 2.

The retaining devices 2 have in each case clamping devices 4, in particular clamping jaws, in order to clamp in, and thus fix, an element to be fixed or a corresponding component.

The retaining devices 2 are also designed to be height-adjustable independently of one another (compare FIG. 2), in order to adjust the components in the powder bed at the same level or the same height along a building-up direction (vertical Z direction) for the powder bed-based additive manufacturing in the device 100. This may be necessary in order to carry out the additive method, in particular the powder coating, expediently.

FIG. 2 shows at least part of the device 100 in an enlarged representation. Also shown in particular in FIG. 2 is a guide 6 of the device 100. The guide 6 is advantageously led through a bore or opening in the baseplate 1 and connected to the retaining device 2. Also shown enlarged are the clamping devices 4 described above. Advantageously two clamping jaws or a pair of clamping jaws are provided for each retaining device 2. Retaining or fixing surfaces of the clamping jaws may be of a firtree-like configuration, in order to grip and fix the root of a blade, advantageously a moving turbine blade, expediently.

Advantageously, at least one of the clamping jaws of each retaining device 2 is movable, in order to fix the component (not explicitly shown in FIG. 2). In the present case, it is indicated by the horizontal arrow of the right-hand clamping jaw in FIG. 2 that it can be pressed against the left-hand clamping jaw, for example for fixing the component 10. This can be performed by measures known to a person skilled in the art.

The device 100 also has a carrier 7. The carrier 7 advantageously connects the clamping jaws 4 to the guide 6 or couples them.

The device 100 also has means 5 in order to make the retaining device 2 and/or the carrier 7 height-adjustable, i.e. for example adjustable along a building-up direction (compare the vertical arrow on the right-hand side in FIG. 2). A thread 8 may be used for this purpose.

The means 5 may be for example an electromechanical means, such as stepping motors. Furthermore, a height adjustment of the retaining device may be accomplished by hydraulic, pneumatic or similar mechanical means, or even piezoelectrics.

The described means for the height adjustment, in particular stepping motors, are also arranged under the baseplate, that is to say outside a powder space during the operation of the device 100. Furthermore, the guide 6 is sealed off from the powder bed, which during operation of the device 100 is arranged above the baseplate 1, for example by means known to a person skilled in the art.

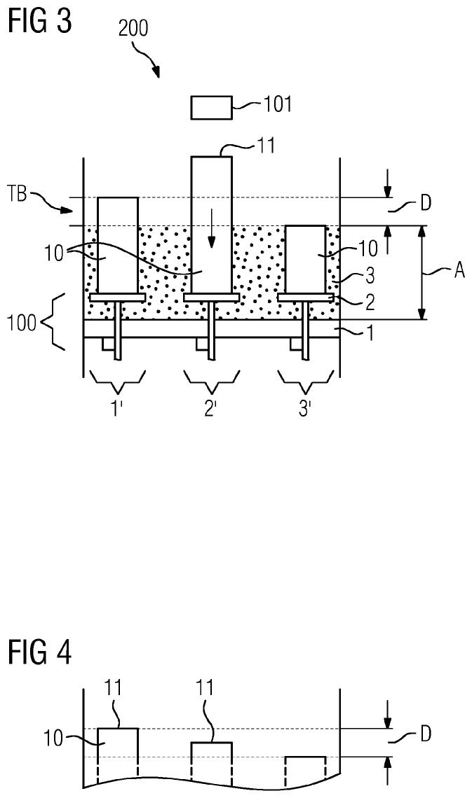

FIG. 3 shows a schematic sectional view of the device 100, which is used in an installation 200 for additive manufacturing. The device 100 is advantageously used in a method for additive manufacturing (compare FIG. 5 further below). FIG. 3 also indicates some of the method steps of the method described.

Shown by way of example are three retaining devices 2, which for the sake of overall clarity are numbered using the curly brackets. Each of the retaining devices 2 fixes or retains the component 10, expediently by way of the clamping jaws, as described in FIGS. 1 and 2.

The components are advantageously turbine blades, in particular moving turbine blades. The components 10 may accordingly be cast components 10, in particular produced by precision investment casting, such as vacuum precision investment casting. In particular, the components 10 are advantageously identical, in particular worn parts for the same power generating plant or industrial installation. The components 10 are advantageously exposed to great wear during operation, for example due to corrosive or mechanical effects, for which reason they have to be repaired or refurbished after certain operating intervals. For this purpose, an airfoil tip is advantageously machined and material removed, and a structural peak or building-up area 11 is thereby defined.

Each of the components 10 accordingly has the peak 11 (structural peak), on which material is to be built up in a later step by the method described, and thus the component is to be refurbished. The structural peaks 11 of the components 10 shown by way of example are shown at different heights (vertical positions) in the device 100. The reason for this is that the length of the component or airfoil is subject to a certain variation.

The method presented thus comprises the individual setting or adjusting of the heights of the components 10 by the retaining device or the described means, in relation to the baseplate, so that the structural peaks 11 are arranged or are at a distance from the baseplate 1 within a predetermined tolerance range TB. The predetermined tolerance range TB, measured along the building-up direction, is 10 to 80 μm, advantageously 20 to 30 μm.

Advantageously, a renewed setting or checking of the height or vertical position of the components is performed after each layer of building-up material, in particular comprising the hardened alloy that is expedient for the blades, built up or fused in a later step.

In order to be able to set the height correspondingly (individually), the method comprises a height measurement within the device 100, or the installation 200 comprising it, advantageously by means of laser distance measurement, when the elements are already covered with powder. The height measurement may be performed in relation to the baseplate and/or in relation to a surface of the powder bed.

The filling with or providing of the powder 3 (powder bed) or building-up material may in principle be performed in this case before or after the setting of the height or vertical position.

In particular, it is shown in FIG. 3 that the build-up with the number 1′ (compare left-hand side) has been set in such a way that the corresponding component or its structural peak 11 is arranged within the tolerance range, to be more precise at the upper limit of the tolerance range. The build-up shown with the number 3′ (compare right-hand side) has been set in terms of height in such a way that the structural peak 11 of the right-hand component 10 is arranged approximately at the lower limit of the tolerance range TB (compare distance A). Only the build-up of the middle component (compare designation 2′) is arranged far outside the powder bed and the tolerance range TB, for example on account of its state of wear, so that a setting of the position is required. If this setting according to the method described were not performed, a coater unit (not explicitly shown here) for the additive building up would run into the peak of the middle component 10, and under some circumstances would cause damage to the installation 200 by a collision.

Advantageously, the position is set or the tolerance range TB is chosen in such a way that it corresponds to a predetermined layer thickness D of the powder to be applied. By this refinement, the damage to the installation described above can indeed be prevented, and at the same time however a reliable build-up of material on the structural peaks 11 or corresponding building-up areas can be ensured.

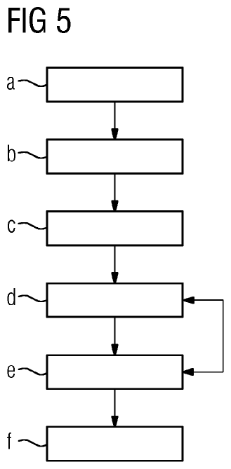

FIG. 4 shows parts of the device 100 or installation 200 that is represented in FIG. 3, wherein a height or vertical position of the “build-up”, comprising the middle retaining device 2 together with the fixed component 10, is corrected with the aid of the method described, or is set in such a way that the corresponding structural peak 11 lies within the tolerance range TB with respect to its height or its distance from the baseplate 1.

FIG. 5 shows a schematic flow diagram of method steps according to the invention. The method is, as described above, a method for the powder bed-based, additive building up of a plurality of the components described.

The method may comprise, according to method steps a), the removal of material in a worn region of the components, in particular in such a way that a structural peak 11 of the components is in this way defined.

The method also comprises, according to method steps b), the fixing of each of the components 10 on a baseplate 1 by means of a retaining device 2.

According to method steps c), the method comprises the measuring of a distance of each structural peak 11 of the components 10 in relation to the baseplate 1 during the actual additive building up (compare method step f) further below).

According to method steps d), the method comprises the setting of a vertical position of at least some of the fixed components 10 in relation to the baseplate 1, so that a structural peak 11 of each component 10 is at a distance from the baseplate 1 within a predetermined tolerance range TB.

According to method steps e), the method comprises the providing of a powder bed 3 of the building-up material on the baseplate 1 up to a height of the tolerance range TB.

The arrow in the flow diagram of FIG. 5 indicates that this method step (providing) may be carried out before or after the setting step (method steps d)), so that the sequence of the steps d) and e) may be changed over.

According to method step f), the method comprises the additive building up of material layer by layer, in each case on the structural peak 11, in particular in order to additively restore or refurbish a worn region of the components 10 (cf. structural peak 11).

Instead of, as described above, filling the entire powder space (not explicitly indicated) with powder or providing a complete powder bed, it may likewise be envisaged merely to place or arrange a frame or sealing template around each of the individual components or airfoil tips to be built up, in order that not the entire building space is filled with powder, and building-up material can be saved. Such elements may be connected to the baseplate 1 for example with the aid of a silicone seal around the components 10 or retaining devices 2.

The invention is not restricted by the description of the invention on the basis of the exemplary embodiments to these embodiments, but rather comprises any novel feature and any combination of features. This includes in particular any combination of features in the patent claims, even if this feature or this combination itself is not explicitly specified in the patent claims or exemplary embodiments.

1.-12. (canceled)

13. A method for powder bed-based additive building up of a plurality of components, the method comprising:
fixing each of the components on a baseplate by a retaining device,
setting a vertical position of at least some of the fixed components in relation to the baseplate, so that a structural peak of each component is at a distance from the baseplate within a predetermined tolerance range,
providing a powder bed of a building-up material on the baseplate up to a height of the predetermined tolerance range, and
additively building up material layer by layer, in each case on the structural peak of the components, wherein a nominal layer thickness for the additive building up of layers corresponds to a dimension of the predetermined tolerance range at a distance from the baseplate.

14. The method as claimed in claim 13,
wherein the setting of the vertical position, and/or a check of the vertical position, is carried out after each built-up layer of material.

15. The method as claimed in claim 13,
wherein the components are repair components and
wherein, before the fixing, material is in each case removed in a worn region of the components, and the structural peak is thus defined.

16. The method as claimed in claim 13,
wherein the components are cast components, and/or
wherein the components are produced by precision investment casting, and/or
wherein the components are produced by vacuum precision investment casting.

17. The method as claimed in claim 13,
wherein the components are identical, and/or
wherein the components are moving turbine blades and the structural peak represents an airfoil tip.

18. The method as claimed in claim 13,
wherein a distance of each structural peak of the components in relation to the baseplate, and/or in relation to a surface of the powder bed, is measured or laser measured, during the additive building up of layers.

19. The method as claimed in claim 13,
wherein the predetermined tolerance range, measured along a building-up direction, is 10 μm to 80 μm

20. The method as claimed in claim 13,
wherein the predetermined tolerance range, measured along a building-up direction, is 20 μm to 30 μm.

21. A device for powder bed-based additive manufacturing, comprising:
a baseplate, and
a plurality of retaining devices that are height-adjustable independently of one another in relation to the baseplate,
wherein the retaining devices are respectively designed to fix a component in relation to the baseplate.

22. The device as claimed in claim 21,
wherein each retaining device is designed to be height-adjustable by way of a guide in the baseplate.

23. The device as claimed in claim 21,
wherein each retaining device has a carrier and/or a clamping device, and
wherein each retaining device is designed to be height-adjustable in relation to the baseplate hydraulically, pneumatically, electromechanically or piezoelectrically.

24. The device as claimed in claim 21, further comprising:
at least four retaining devices.
